(19) United States
(12) Patent Application Publication
(10) Pub. No.: US 2019/0155592 A1
(43) Pub. Date: May 23, 2019

(54) Method for Configuring an Electronic Component

(71) Applicant: Robert Bosch GmbH, Stuttgart (DE)

(72) Inventors: Sebastian Vornwald, Wuerzburg (DE); Adrien Mouaffo Tiadjio, Neu-Ulm (DE); Christoph Maier, Kleinostheim (DE); Jochen Mueller, Backnang (DE); Patric Brand, Sennfeld (DE); Peter Rehbein, Erlabrunn (DE); Roman Ritter, Stuttgart (DE); Thomas Inderwies, Frammersbach (DE); Wolfgang Rueppel, Frammersbach (DE)

(21) Appl. No.: 16/194,457

(22) Filed: Nov. 19, 2018

(30) Foreign Application Priority Data
Nov. 20, 2017 (DE) 10 2017 220 698.5

(51) Int. Cl. G06F 8/65; H04L 29/08; H04B 5/00; G06K 7/10; H04W 8/00

(52) U.S. Cl. CPC G06F 8/65; H04L 67/34; H04W 8/005; G06K 7/10009; H04B 5/0031

(57) ABSTRACT

A method for configuring an electronic component includes identifying the electronic component, identifying at least one operating component which is assigned to the electronic component in such a manner that a state of the at least one operating component can be captured using the electronic component, and transmitting at least one configuration signal to the identified electronic component based on the identified at least one operating component.

This application claims priority under 35 U.S.C. § 119 to patent application no. DE 10 2017 220 698.5, filed on Nov. 20, 2017 in Germany, the disclosure of which is incorporated herein by reference in its entirety.

### BACKGROUND

Electronic components which are intended and set up for a very limited functionality are known. Such electronic components can also be referred to as embedded systems. On account of an only small storage capacity, only software with a very limited functionality can be installed on such electronic components. It is not possible to implement all conceivable applications within software for an embedded system on account of limited memory. In order to be able to use the possibilities arising from the hardware of such electronic components and also to update the software, it is therefore usually necessary to load new software onto the electronic component and to install it on the latter. It may also be necessary to change or update a setting of the software and/or data which are stored on the electronic component and can be accessed by the software.

### SUMMARY

On the basis of this, the object of the disclosure is to solve or at least reduce the technical problems described in connection with the prior art. In particular, the intention is to present a method for configuring an electronic component, with which the electronic component can be configured in a particularly simple manner and software, in particular, can be installed on the electronic component in a particularly simple manner.

This object is achieved with a method for configuring an electronic component as described herein. Further advantageous configurations of the method are stated in the dependent patent claims. The features individually cited in the patent claims can be combined with one another in any desired, technologically useful manner and can be supplemented with explanatory substantive matter from the description, in which case further embodiment variants of the disclosure are shown.

A method for configuring an electronic component is presented here, which method comprises at least the following method steps of:

a) identifying the electronic component,
b) identifying at least one operating component which is assigned to the electronic component in such a manner that a state of the at least one operating component can be captured using the electronic component, and
c) transmitting at least one configuration signal to the electronic component on the basis of the electronic component identified according to step a) and on the basis of the at least one operating component identified according to step b).

The electronic component may be, in particular, an embedded system. This means, in particular, that the electronic component can be intended and set up to record one or more measurement variables and to transmit them to a data network. In particular, a temperature, a magnetic field (which can be characterized by a direction and/or an absolute value), an acceleration (which can be characterized by a direction and/or an absolute value) and/or a light intensity can therefore be measured or determined from a measured value. The electronic component preferably comprises at least one sensor which is suitable for this purpose. The electronic component can be referred to as a sensor component. It is also preferred for the electronic component to be designed in such a manner that measured values recorded using the sensors can be transmitted in a contactless manner, for example via radio, Bluetooth®, WLAN, infrared and/or mobile radio. Accordingly, the electronic component can also be referred to as a “sensor connectivity device”.

The electronic component is preferably intended and set up to be fitted to a machine tool, a production machine, a vehicle or an industrial plant, for example. In this case, measured values can be measured at one or more different positions using one or more of the electronic components described. For example, measured values can be recorded at valves for operating a machine or plant. Acceleration values can be used to detect, for example, damage to a machine part, in particular as a result of a limit value being exceeded. The electronic component can also be provided on objects and/or shelves in a warehouse. Vibrations captured using the acceleration sensor can be used to detect damage to the stored objects and/or to the shelves.

The electronic component is preferably autonomous, with the result that there is no need for any cable connection (either to supply energy to the electronic component or to transmit information) to the electronic component, in particular.

The electronic component preferably has a battery or an autonomous energy producer (for example a solar cell or a generator) which can be used to supply the sensors and/or a transmitting element for transmitting measured values (only) with energy, for example.

It is also preferred for the electronic component to be closed in such a manner that no water can enter the electronic component from the outside, for example. In that case, it is preferred for the electronic component to not have a mechanical user interface, for example a switch, via which a user can interact with the electronic component. Instead, the interaction between the user and the electronic component preferably takes place in a contactless manner. This makes it possible to permanently avoid entry of water into the electronic component, for example.

The electronic component also preferably has a memory and a microprocessor. The microprocessor can be used to control the functionality of the electronic component, wherein data and/or instructions from the memory can be accessed.

The electronic component can be configured using the described method. This means, in particular, that data are stored in a memory of the electronic component, are deleted from said memory and/or are changed in said memory. Program instructions, parameters and/or settings, in particular, can therefore be changed. In the described method, the configuration is carried out in a contactless manner. Therefore, there is no need for a cable connection to the electronic component for the configuration by means of the described method either. The described method enables a particularly great variance of applications with the same hardware of the electronic component without having to already consider all possible applications in advance here in a memory of the electronic component.

The electronic component is identified in step a) of the described method.

The described method can be intended and set up for a multiplicity of different electronic components with different hardware. In this case, each of the electronic components may require a different configuration. For example, the configuration of an electronic component having a temperature sensor may comprise setting the measurement range of the temperature sensor, whereas the configuration of a (different) electronic component having an acceleration sensor may comprise setting the acceleration sensor. Step a) of the described method can contribute, in particular, to determining or defining the configuration to be carried out.

At least one operating component which is assigned to the electronic component in such a manner that a state or a property of the at least one operating component can be captured using the electronic component is identified in step b) of the described method.

The at least one operating component may be, for example, a component of a machine tool, a production machine, a vehicle or an industrial plant. For example, the operating component may be a valve, an actuator, a motor or a passive structure, for example a carrier construction. The at least one operating component may be in the form of a mechanical component, in particular.

Measured values based on the operating component can be recorded, in particular, using the electronic component. In this respect, the operating component can be considered to be “passive” and the electronic component can be considered to be “active”. The at least one operating component is preferably part of a plant such as a machine tool, a production machine, a vehicle or an industrial plant. Without having to make further changes to the plant, it is possible to capture information based on the operating component by fitting the electronic component to the at least one operating component.

The configuration of the electronic component to be carried out can also depend, in particular, on what operating component the electronic component is assigned to. It is thus preferred, in particular, for the electronic component to have the same hardware for a multiplicity of envisaged applications and, in particular, for all envisaged applications. This therefore means that the electronic component can be produced in a particularly large quantity and therefore in a particularly cost-effective manner. Individualization can be carried out by means of the configuration according to the described method.

If the electronic component has sensors for a magnetic field, an acceleration and a light intensity, for example, the configuration may provide for the various sensors to be activated or deactivated depending on the application. For example, activation only of the acceleration sensor may be provided for the purpose of monitoring a valve as the at least one operating component. The acceleration sensor can be used to measure a vibration arising during the opening and/or closing of the valve if the electronic component is adhesively bonded to a housing of the valve, for example. The electronic component can therefore be used to capture, for example, when the valve has switched. In order to monitor a motor as the at least one operating component, provision may be made, for example, for only the temperature sensor to be activated. The electronic component can thus be used to monitor when the electronic component is adhesively bonded to a housing of the motor, for example. Overheating of the motor, in particular, can thus be detected.

A different configuration can therefore be provided for each operating component. In particular, the configuration to be carried out may depend on the combination of the at least one operating component and the electronic component. The configuration to be carried out in a particular case can be determined accordingly. In particular, at least one configuration signal is transmitted to the electronic component for this purpose in step c) of the described method on the basis of the electronic component identified according to step a) and on the basis of the at least one operating component identified according to step b).

The at least one configuration signal preferably comprises data which are intended to be written to a memory of the electronic component. The at least one configuration signal preferably also comprises details relating to which data are to be replaced or deleted in the memory of the electronic component. The at least one configuration signal therefore comprises all details and data needed to carry out the configuration.

The at least one configuration signal is preferably created by a configuration device. For this purpose, the details and data required for the configuration to be carried out can be coded, in particular, in such a manner that transmission to the electronic component is possible.

The configuration device may be, in particular, a (mobile) smartphone or tablet or a (stationary) operating unit. The configuration device is preferably set up in such a manner that the electronic component and/or the at least one operating component can be identified using the configuration device according to step a) and/or b). This can be carried out, for example, by inputting a serial number of the electronic component and/or of the at least one operating component.

The data and details required for the configuration to be carried out can be stored, in particular, in a memory of the configuration device. Alternatively or additionally, however, the data and details required for the configuration to be carried out can also be loaded from an external data storage medium and/or via a data connection.

The embodiment of the method in which the at least one configuration signal transmitted in step c) is created using access to a data network is thus preferred.

In this embodiment, the data and details required for the configuration to be carried out are preferably stored on a server of the data network and can be loaded from said server. The at least one configuration signal can be created from the data and details loaded in this manner using the configuration device.

The data network is preferably a (data) cloud. It may also be a computer network. The data network can be accessed using the configuration device, in particular via a wireless connection such as a WLAN or mobile radio connection.

The data network preferably comprises a database which stores the corresponding configuration to be carried out for all envisaged combinations of the electronic component and the operating component. The configuration to be carried out in each case can be present in the database, in particular in the most up-to-date version in each case. The electronic component can therefore be configured using the configuration device (that is to say using a smartphone, in particular) without a large volume of data having to be stored in the configuration device. It suffices for the smartphone to identify the electronic component and the at least one operating component, to load the configuration to be accordingly carried out from the data network and to transmit it to the electronic component.

In another preferred embodiment of the method, at least the electronic component in step a) or the at least one operating component in step b) is identified using at least near-field communication or optical capture.

Both the electronic component in step a) and the at least one operating component in step b) are preferably identified using near-field communication. Alternatively or additionally, it is preferred for both the electronic component in step a) and the at least one operating component in step b) to be identified using optical capture. It is also possible for the electronic component in step a) to be identified using near-field communication and for the at least one operating component in step b) to be identified using optical capture. It is also possible for the electronic component in step a) to be identified using optical capture and for the at least one operating component in step b) to be identified using near-field communication.

Near-field communication is also known as NFC for short. During near-field communication, electromagnetic signals are interchanged over short distances of up to 5 cm, for example. For identification by means of near-field communication, the electronic component and/or the at least one operating component preferably has/have a near-field communication module which can also be referred to as an NFC module for short. In particular, a so-called “NFC tag” can be provided on the at least one operating component and/or on the electronic component. The electronic component itself may also be in the form of an “NFC tag” or may comprise such a tag. A serial number, in particular, can be captured using an “NFC tag” by means of near-field communication. For example, the serial number of the at least one operating component and/or of the electronic component can be captured using a smartphone by virtue of the smartphone, which has a corresponding transmitting and receiving apparatus, being held to the “NFC tag”.

A serial number can also be optically captured. The serial number may thus be coded as a barcode or as a QR code and may be fitted to the at least one operating component and/or to the electronic component. The serial number can also be fitted as such (that is to say with readable digits) to the at least one operating component and/or to the electronic component. The serial number can be optically captured with character recognition, for example using a camera of a smartphone.

The at least one operating component and/or the electronic component can also be optically identified by virtue of software recognizing a shape and/or particular optical features of the respective component in a camera image.

When the electronic component is activated, the electronic component can be configured by means of the described method. For this purpose, the type of the at least one operating component can be identified, in particular, using a network-enabled terminal (such as a smartphone), for example by inputting the type part number or by photographing the component and/or its type label. The device to be programmed can also be identified by means of near-field communication (NFC), for example. A connection to a “cloud backend” can then be established and data loaded therefrom can be transmitted to the electronic component as the at least one configuration signal.

In another preferred embodiment of the method, software is generated in step c), is transmitted to the electronic component via the at least one configuration signal and is installed on the electronic component.

The configuration of the electronic component may comprise, in particular, the installation of software, in particular on the microprocessor of the electronic component. The software and its installation data are preferably prepared on the configuration device as far as possible, with the result that the electronic device itself does not have to provide any particularly great computing power. The software to be installed can be generated in the data network and/or on the configuration device.

The data network can also be referred to as a “backend”. This data network preferably generates suitable software on the basis of parameters for identifying the components, as determined according to steps a) and b), and transmits this software to the network-enabled terminal. The electronic component to be configured (that is to say to be programmed, in particular) is then preferably programmed using the generated software.

In another preferred embodiment of the method, the software is executed using the electronic component immediately after the software has been installed on the electronic component.

The software installed on the electronic component or on its microprocessor is preferably designed in such a manner that it is executed as intended even without interacting with a user. For example, provision may be made for measured values to be recorded at predetermined intervals of time and to be transmitted to a particular receiver (for example via a Bluetooth® or radio interface). The software is preferably executed after activation. In the present embodiment, the activation is carried out immediately after the software has been installed. This may be useful, in particular, when the electronic component is configured as described at its intended location and can therefore operate as intended immediately after the configuration.

A method is presented as a further aspect, in which the electronic component is reconfigured at least once from a first configuration into a second configuration in accordance with the method described above, wherein the electronic component in the first configuration is set up for use with a first operating component and in a first operating mode, and wherein the electronic component in the second configuration is set up for use with a second operating component and/or in a second operating mode.

The special advantages and configuration features described for the method for configuring an electronic component can be applied and transferred to the present method for operating an electronic component and vice versa.

With the method for operating an electronic component, the electronic component can be used for different tasks at different times. In particular, the electronic component can thus be used for different operating components at different times.

For this purpose, the electronic component can be reconfigured from the first configuration into the second configuration. In this case, the first configuration is a configuration, on the basis of which a reconfiguration is carried out. The second configuration is the configuration resulting therefrom. The fact that the electronic component can also be reconfigured more than once from a first configuration into a second configuration should be understood as meaning the fact that the second configuration in a cycle is the first configuration in a subsequent cycle. In this respect, a particular configuration can be both a first configuration and a second configuration. There may also be a multiplicity of first and second configurations.

The individual configurations differ in that they are provided for a respective combination of an operating component and an operating mode. The combination of the first operating component and the first operating mode differs from the combination of the second operating component and the second operating mode. This may be the case as a result of the fact that the first operating component differs from the second operating component and/or the first operating mode differs from the second operating mode. The second operating component in a cycle may be the first operating component in a subsequent cycle. The second operating mode in a cycle may be the first operating mode in a subsequent cycle.

A sequence of actions to be carried out comes into consideration as an operating mode, in particular. In a first operating mode, provision may therefore be made, for example, for temperature measured values to be measured at first predefined intervals of time. In a second operating mode, provision may be made for acceleration values to be measured at first or second predefined intervals of time. In a third operating mode, provision may be made for acceleration values to be measured at second predefined intervals of time.

An electronic component which can be configured using the described method for configuring an electronic component is presented as a further aspect.

The special advantages and configuration features described for the method for configuring an electronic component and for the method for operating an electronic component can be applied and transferred to the electronic component.

A configuration device which is set up to carry out the described method for configuring an electronic component is presented as a further aspect.

The special advantages and configuration features described for the method for configuring an electronic component and for the method for operating an electronic component can be applied and transferred to the configuration device.

A data network which is set up to carry out the described method for configuring an electronic component is presented as a further aspect.

The special advantages and configuration features described for the method for configuring an electronic component and for the method for operating an electronic component can be applied and transferred to the data network.

The disclosure and the technical environment are explained in more detail below on the basis of the figures. The figures show an exemplary embodiment, to which the disclosure is not restricted, however. For clarification, it should be pointed out that the technical features illustrated in the figures can also be combined with features in other figures and/or the description without the need to adopt other technical features in a figure. If there is a technical need to combine characteristics of a technical feature with those of another technical feature, reference is explicitly made to this, with the result that it is otherwise possible to freely combine these features.

### BRIEF DESCRIPTION OF THE DRAWINGS

In the figures:

FIG. 1: schematically shows an illustration of an electronic component, an operating component, a configuration device and a data network,

FIG. 2: schematically shows a first illustration of a method for configuring the electronic component from FIG. 1,

FIG. 3: schematically shows a second illustration of the method from FIG. 2, and

FIG. 4: schematically shows an illustration of a work machine having a plurality of electronic components according to the embodiment from FIGS. 1 and 2.

### DETAILED DESCRIPTION

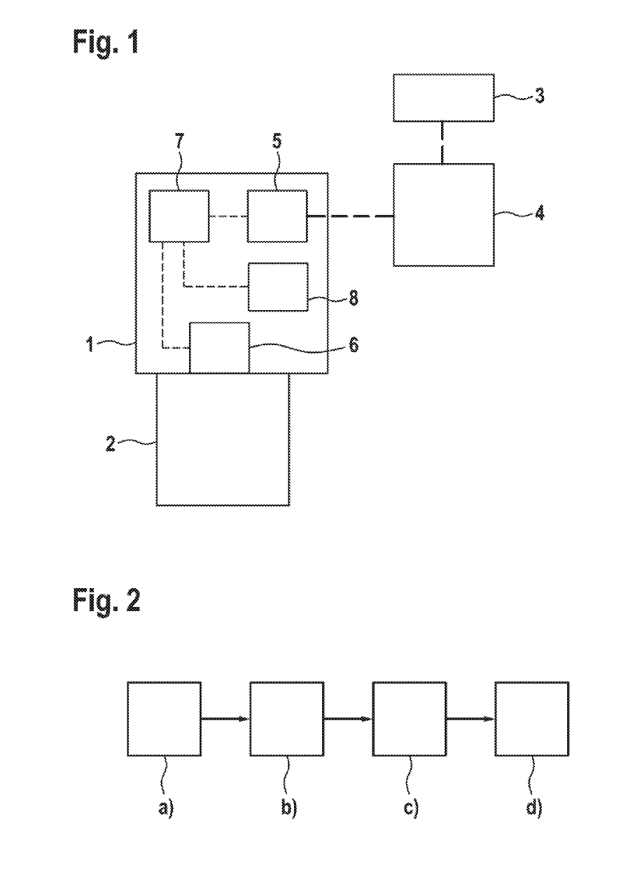

FIG. 1 shows an electronic component 1 and an operating component 2 which is assigned to the electronic component 1 in such a manner that a state of the operating component 2 can be captured using the electronic component 1. The assignment of the operating component 2 to the electronic component 1 is indicated in FIG. 1 by the fact that the operating component 2 and the electronic component 1 are touching one another. For example, a temperature and/or vibrations can be transmitted from the operating component 2 to the electronic component 1 and can be measured by the latter. The electronic component 1 has a sensor 6 for this purpose.

The electronic component also has a memory 8 and a microprocessor 7. The microprocessor 7 can be used to control the functionality of the electronic component 1, wherein data and/or instructions from the memory 8 can be accessed.

The electronic component 2 can be connected to a configuration device 4 via a near-field communication module 5, which is indicated by a dashed line. The electronic component 1 can be configured via the configuration device 4. For this purpose, the configuration device 4 can access a data network 3, which is likewise indicated by a dashed line.

FIG. 2 shows a first schematic illustration of a method for configuring the electronic component 1 from FIG. 1. The method comprises the following method steps of:

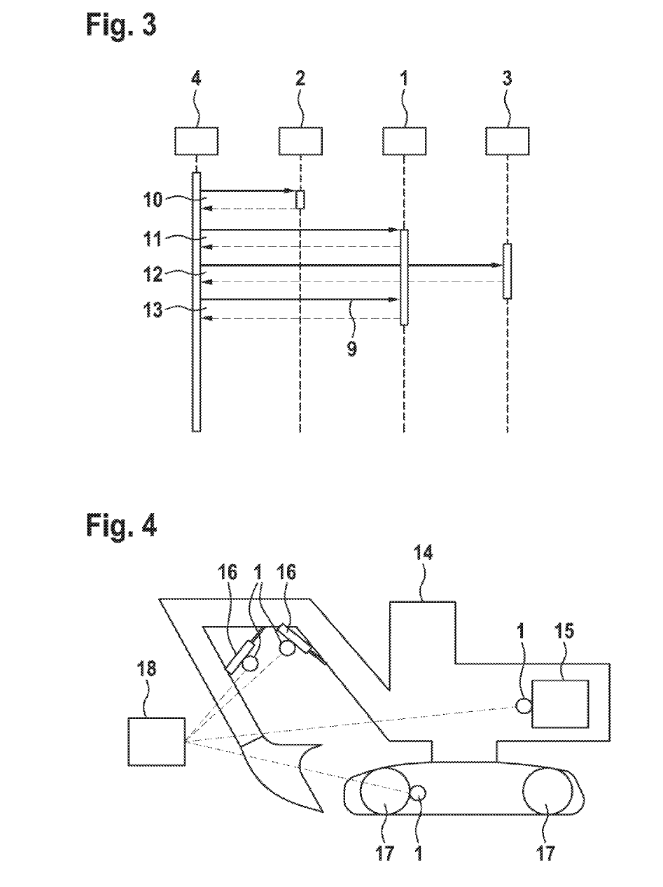

a) identifying the electronic component 1,
b) identifying the operating component 2, and
c) transmitting at least one configuration signal 9 (shown in FIG. 3) to the electronic component 1 on the basis of the electronic component 1 identified according to step a) and on the basis of the operating component 2 identified according to step b).

The at least one configuration signal 9 transmitted in step c) is created using access to the data network 3. At least the electronic component 1 in step a) or the at least one operating component 2 in step b) is identified using near-field communication and/or optical capture. Software is generated in step c), is transmitted to the electronic component 1 via the at least one configuration signal 9 and is installed on the electronic component 1. The software is executed using the electronic component 1 immediately after the software has been installed on the electronic component 1.

FIG. 3 shows a second illustration of the method from FIG. 1. An identification 10 of the operating component 2, an identification 11 of the electronic component 1 and access 12 to the data network 3 can be seen. The configuration signal 9 is then transmitted 13 to the electronic component. The method is carried out using the configuration device 4.

FIG. 4 shows a work machine 14. An electronic component 1 according to the embodiment from FIG. 1 is respectively provided on a motor 15, on two hydraulic units 16 and on a chain drive 17. The motor 15, the two hydraulic units 16 and the chain drive 17 are operating components 2. Measured values can be recorded using the electronic components 1 and can be transmitted to a receiver 18. A temperature of the motor 15 and vibrations of the chain drive 17 and of the hydraulic units 16 can therefore be measured, for example.

### LIST OF REFERENCE SIGNS

1 Electronic component
2 Operating component
3 Data network
4 Configuration device
5 Near-field communication module
6 Sensor
7 Microprocessor
8 Memory
9 Configuration signal
10 Identification
11 Identification
12 Access
13 Transmission
14 Work machine
15 Motor
16 Hydraulic unit
17 Chain drive
18 Receiver

What is claimed is:

1. A method for configuring an electronic component, comprising:
identifying the electronic component;
identifying at least one operating component assigned to the electronic component, such that a state of the at least one operating component is captured using the electronic component; and
transmitting at least one configuration signal to the identified electronic component based on the identified electronic component and the identified at least one operating component.

2. The method according to claim 1, further comprising:
creating the at least one configuration signal using access to a data network.

3. The method according to claim 1, further comprising:
identifying at least one of the electronic component and the at least one operating component using near-field communication or optical capture.

4. The method according to claim 1, wherein:
generating the at least one configuration signal includes generating software, and
the method further comprises transmitting the generated software to the identified electronic component via the at least one configuration signal, and installing the transmitted software on the identified electronic component.

5. The method according to claim 4, further comprising:
immediately executing the generated software using the electronic component after the generated software has been installed on the identified electronic component.

6. The method according to claim 1, wherein:
the identified electronic component is reconfigured at least once from a first configuration into a second configuration according to the method,
the identified electronic component in the first configuration is set up for use with a first operating component and in a first operating mode, and
the identified electronic component in the second configuration is set up for use with a second operating component and/or in a second operating mode.

7. The method according to claim 1, wherein a configuration device is configured to carry out the method.
